(19) United States
(12) Patent Application Publication
(10) Pub. No.: US 2002/0004541 A1
(43) Pub. Date: Jan. 10, 2002

(54) Reduced pour point surfactants

(75) Inventors: David Charles Lewis, Austin, TX (US); Donald Hugh Champion, Pflugerville, TX (US)

Correspondence Address: Russell R. Stolle, Huntsman Corporation, P.O. Box 15730, Austin, TX, 78761, US

(73) Assignee: Huntsman Petrochemical Corporation, Austin, TX (US)

(21) Appl. No.: 09/905,237

(22) Filed: Jul. 13, 2001

Related U.S. Application Data
(63) Continuation-in-part of application No. 09/419,840, filed on Oct. 15, 1999.

(51) Int. Cl. C08K 5/42; C08K 5/05

(52) U.S. Cl. 524/157; 524/386; 524/166

(57) ABSTRACT

Reduced pour point ethylene oxide/propylene oxide block copolymer surfactants, pour point depressants for reducing the pour point of such surfactants, and a process for preparing such surfactants, wherein the reduced pour point is achieved without adversely affecting the properties or structure of the parent ethylene oxide/propylene oxide block copolymer surfactant or contributing to the formation of a hazy product. According to the present invention, the pour point of ethylene oxide/propylene oxide block copolymer surfactants may be reduced by mixing a parent ethylene oxide/propylene oxide block copolymer surfactant with a pour point depressant comprising a low molecular weight glycol, water, and a dialkyl sulfosuccinate.

This application is a continuation-in-part of pending U.S. application Ser. No. 09/419,840 filed Oct. 15, 1999, currently still pending, the entire contents of which are herein incorporated fully by reference thereto.

### TECHNICAL FIELD

This invention relates to surfactants, and more particularly it relates to ethylene oxide/propylene oxide block copolymer surfactants having reduced pour points, to pour point depressants for reducing the pour point of such surfactants, and to a process for preparing such reduced pour point surfactants.

### BACKGROUND OF THE INVENTION

The pour point of a liquid substance is defined as the lowest temperature at which the liquid substance will flow when a test container containing the liquid substance is inverted, such as the procedure outlined in test method ASTM D-97. The pour point of a substance may need to be lowered or raised for numerous reasons. For example, the pour point of a solid compound may need to be lowered if a particular application requires that the compound be in a fluid form. Alternatively, the pour point of a fluid compound may need to be lowered if the compound is to be used under low-temperature applications that require that the compound remain fluid at such reduced temperatures.

In the field of surfactants, ethylene oxide/propylene oxide block copolymer surfactants with more than about thirty percent ethylene oxide tend to be solids or pastes at room temperature. Unfortunately, several of the applications for these surfactants require that such surfactants be in a liquid form. Due to the inconvenience associated with liquefying such surfactants, numerous methods have been developed to reduce the pour point of such surfactants. However, many of these methods either adversely alter the properties or structure of the parent surfactant or result in a hazy product. According to one conventional method, additives, known as “pour point depressants” to those skilled in the art, are added to the surfactant to reduce its pour point. However, the addition of pour point depressants can alter the properties of the parent surfactant and/or results in the production of a hazy product.

Another conventional method involves the use of multiple blocking, wherein alternating blocks of ethylene oxide and propylene oxide are introduced into the surfactant structure to reduce the pour point of the parent surfactant. While this method may reduce the pour point of the resulting surfactant, the structure of the parent surfactant is altered, and the resulting surfactant product frequently has different properties than the parent surfactant.

Therefore, what is needed are reduced pour point ethylene oxide/propylene oxide block copolymer surfactants, pour point depressants for reducing the pour point of such surfactants, and a process for preparing such reduced pour point surfactants, wherein the pour point of the surfactants is reduced without adversely affecting the properties or structure of the parent surfactant or contributing to the formation of a hazy product.

### SUMMARY OF THE INVENTION

The present invention provides for reduced pour point ethylene oxide/propylene oxide block copolymer surfactants, pour point depressants for reducing the pour point of such surfactants, and a process for preparing such surfactants, wherein the pour point of the surfactants is reduced without adversely affecting the properties or structure of the parent surfactant or contributing to the formation of a hazy product.

According to one aspect of the present invention, reduced pour point ethylene oxide/propylene oxide block copolymer surfactants are disclosed. The reduced pour point ethylene oxide/propylene oxide block copolymer surfactants are prepared by mixing a parent ethylene oxide/propylene oxide block copolymer surfactant with a pour point depressant comprising a low molecular weight glycol, water, and a dialkyl sulfosuccinate.

According to another aspect of the present invention, a process for preparing reduced pour point ethylene oxide/propylene oxide block copolymer surfactants is disclosed. According to this process, a parent ethylene oxide/propylene oxide block copolymer surfactant is blended with a pour point depressant comprising a low molecular weight glycol, water, and a dialkyl sulfosuccinate.

According to yet another aspect of the present invention, pour point depressants for reducing the pour point of ethylene oxide/propylene oxide block copolymer surfactants are disclosed. The pour point depressants comprise a low molecular weight glycol, water, and a dialkyl sulfosuccinate.

### DETAILED DESCRIPTION

The present invention is directed towards reducing the pour point of ethylene oxide/propylene oxide block copolymer surfactants that are waxy solids or pastes at room temperature. According to the present invention, the pour point of these and other ethylene oxide/propylene oxide block copolymer surfactants may be reduced by the addition of pour point depressants comprising a mixture of a low molecular weight glycol component, a dialkyl sulfosuccinate component, and water. Typically, such solid or waxy ethylene oxide/propylene oxide block copolymer surfactants have an ethylene oxide content greater than about thirty percent, and the melting point of these surfactants is generally observed to increase as the degree of ethoxylation increases. The term “ethylene oxide/propylene oxide block copolymer surfactants” as used herein includes block copolymers (having a polyoxyalkylene oxide backbone) with the general structure:

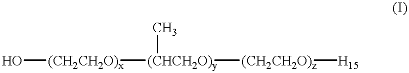

where x, y, and z may each independently represent any integer between 2 and 100, or

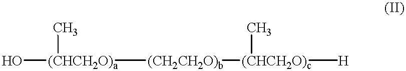

in which a, b, and c may each independently represent any integer between 2 and 100. Such ethylene oxide/propylene oxide block copolymer surfactants are useful in a variety of applications, and are frequently used as additives in agricultural formulations, pigment dispersants, grinding aids, industrial cleaners, metal-working lubricants, rinsing agents, etc. However, the use of such ethylene oxide/propylene oxide block copolymer surfactants in many of these applications has been hindered by the fact that such surfactants are typically waxy solids or pastes at room temperature. For example, the materials of structure (I), when x is in the range of 2 to 75, y is in the range of 2 to 70, z is in the range of 2 to 75, and the total ethylene oxide content of the molecule is greater than about 40 % by weight, are waxy solids at room temperature. The materials of structure (II) when are waxy solids at room temperature when the ethylene oxide content is greater than about 40 %. This is evident from observing the properties of three PO-EO-PO surfactants available from BASF Corporation:

| | | | | | melting |
|---|---|---|---|---|---|
| Product | moles PO | moles EO | moles PO | EO/PO | point |
| Designation | first block | second block | third block | ratio | (° C.) |
| 17R4 | 14 | 24 | 14 | 40/60 | 18° |
| 17R8 | 12 | 127 | 12 | 80/20 | 83° |
| 22R4 | 18 | 30 | 18 | 40/60 | 24° |

Generally, before such solid surfactants can be used, they must be liquefied (i.e. by heating), or the pour point of such surfactants must be depressed by some other means (i.e. through multiple blocking, or through the addition of pour point depressants). Such ethylene oxide/propylene oxide block copolymer surfactants which are solid or waxy at a temperature in the range of about 10 degrees centigrade to 80 degrees centigrade, which are thus unsuitable to is be used at any of these temperatures as pourable or flowable surfactants, are referred to in this specification and the appended claims as a “parent” surfactant, because such surfactants are the ones from which a final surfactant composition or product having a reduced pour point, as provided for herein, are derived.

### The Glycol Component

Preferably, the low molecular weight glycol component comprises propylene glycol, ethylene glycol, diethylene glycol, or mixtures thereof. However, any glycol having a molecular weight of less than 300 may be used in providing a surfactant having a reduced pour point according to the present invention, and such glycols fall within the meaning of “low molecular weight glycol” as used in this specification and the appended claims. Mixtures of any glycols falling within this definition are suitable as the glycol component of a composition according to the invention.

### The Sulfosuccinate Component

Preferably, the sulfosuccinate component of a composition according to the invention useful for reducing the pour point of the aforesaid solid or waxy surfactants comprises a dialkyl sulfosuccinate having alkyl appendages with any number of carbon atoms between about 3 and 15. Thus, any dialkyl sulfosuccinate described by the formula:

[chemical structure]

in which R₁ and R₂ may each independently be any straight-chain or branched alkyl or alkenyl group having between 3 and 15 carbon atoms, including without limitation: propyl, butyl, pentyl, hexyl, heptyl octyl, nonyl, decyl, undecyl, dodecyl tridecyl, tetradecyl, pentadecyl, and all structural isomers of the foregoing. In a preferred embodiment of the invention, both R₁ and R₂ are octyl groups. It is clear that the sulfosuccinate portion of the structure above exists in an anionic form, and charged neutrality is provided by the inclusion of a species M+. The species M+ may be any chemical species capable of providing a positive charge, and suitable species includes such species as alkali metals, alkaline earth metals, ammonium ions, alkylammonium ions, etc. According to one synthesis route for these materials, the dialkyl sulfosuccinic acid is first produced, then reacted with a selected alkaline substance to provide the anionic form of the sulfosuccinate. Thus, any alkaline substance which is capable of reacting with a dialkyl sulfosuccinate to provide the sulfosuccinate in its anionic form is suitable to provide a cationic species defined by M+.

To provide a surfactant according to the invention, the dialkyl sulfosuccinate component may be blended with water and with a lower molecular weight alkylene glycol component, such as propylene glycol, using ordinary agitation, to provide a pre-mix admixture. Such admixture is beneficial towards promoting incorporation of the dialkyl sulfosuccinate into the resulting surfactant product when this pre-mix is blended with a surfactant which is solid or waxy at room temperature. According to one preferred form of the invention, the sulfosuccinate comprises di-octyl sodium sulfosuccinate, blended with about 16% (wt.) water and 11% (wt.) propylene glycol. A product containing such amounts of sodium dioctyl sulfosuccinate, 1,2-propylene glycol, and water is commercially available from the Huntsman Corporation, Ontario, Canada, under the trade name SURFONIC® DOS-75 PG. (All parts and percentages set forth in this specification and the claims appended hereto are stated on a weight basis, unless specifically stated otherwise.)

The pour point depressant combinations according to the invention are typically, without limitation, capable of reducing the pour point of ethylene oxide/propylene oxide block copolymer surfactants by up to 50 degrees centigrade, depending upon the concentration of the sulfosuccinate, water, and glycol components.

According to a preferred form of the invention, the pour point of an ethylene oxide/propylene oxide block copolymer surfactant is depressed by at least 40° C. Typically, to provide a surfactant composition containing an ethylene oxide/propylene oxide block copolymer surfactant having a pour point reduction of about 40 degrees centigrade, such a composition comprises less than about 85% (wt.) of the parent surfactant, at least about 5% (wt.) of the resulting reduced pour point ethylene oxide/propylene oxide block copolymer surfactant composition comprises water, at least about 5% (wt.) of the resulting reduced pour point ethylene oxide/propylene oxide block copolymer surfactant composition comprises a low molecular weight glycol, and at least about 5% (wt.) of the resulting reduced pour point ethylene oxide/propylene oxide block copolymer surfactant composition comprises a dialkyl sulfosuccinate. In one preferred form of the invention, from about 55% (wt.) to about 80% (wt.) of the resulting reduced pour point ethylene oxide/propylene oxide block copolymer surfactant composition comprises a parent surfactant, from about 5% (wt.) to about 15% (wt.) of the resulting reduced pour point ethylene oxide/propylene oxide block copolymer surfactant composition comprises water, from about 5% (wt.) to about 15% (wt.) of the resulting reduced pour point ethylene oxide propylene oxide block copolymer surfactant composition comprises a low molecular weight glycol, and from about 5% (wt.) to about 20% (wt.) of the resulting reduced pour point ethylene oxide/propylene oxide block copolymer surfactant composition comprises a dialkyl sulfosuccinate.

In some cases, depending upon the intended end use of the surfactant, it may not always be desirable to reduce the pour point of an ethylene oxide/propylene oxide block copolymer surfactant to the maximum potential extreme the present invention is capable of providing. Accordingly, the composition of the pour point depressant (i.e. the relative ratio of dialkyl sulfosuccinate:low molecular weight glycol:water) and the relative amount of the pour point depressant that is mixed with the parent surfactant (which may be an ethylene oxide/propylene oxide block copolymer surfactant component) may be adjusted so that the pour point of the resulting surfactant is lowered only to a desired temperature, by adding more or less of the pour point depressant subcombination to the parent surfactant.

In a similar manner, the composition of the pour point depressant and the relative amount of the pour point depressant pre-mix that is mixed with an ethylene oxide/propylene oxide block copolymer surfactant may also be adjusted to compensate for the unique properties of the particular ethylene oxide/propylene oxide block copolymer surfactant being blended with the pour point depressant, the proposed use of the reduced pour point surfactant, etc., which adjustments may be undertaken without undue experimentation in view of the disclosures herein.

One benefit of the addition of the pour point depressant premixes of the present invention to ethylene oxide/propylene oxide block copolymer surfactants does not alter the properties or structure of the parent surfactant. Thus, through use of the present invention, formulators of finished surfactant products are now enabled to reap the benefits of the physical performance characteristics possessed by many surfactants by including such surfactants in formulations previously precluded by the high pour point of those surfactants.

Another advantage of compositions according to the invention is that the surfactants liquefied for easier handling in accordance with the invention may be made to revert back to a solid surfactant when desired, by driving off the water present. This is important in applications such as wettable dry granule formulation for agricultural applications or a solid cleaner formulation. In the formulation of the wettable dry granule or wettable powder pesticides ,the solid nature of the surfactant is used to bind the particles together. If the surfactant had been rendered liquid by prior art methods i.e. by mixing the Ethylene Oxide (“EO”) and Propylene Oxide (“PO”) together in the molecule (heteric) or by multiple blocking of EO and PO, then it is difficult to return the surfactant to the solid state, and the resulting powders and granules will be poorly formed. An additional disadvantage is that the surfactant would leach out of the powders on storage.

As an unexpected additional benefit, it was noticed that the addition of the pour point depressants of the present invention to ethylene oxide/propylene oxide block copolymer surfactants does not result in a hazy product, which is an important factor in satisfying end-users of such products for aesthetic reasons.

It is understood that variations may be made in the foregoing with departing from the scope of the invention. For example, although the pour point depressants of the present invention are primarily discussed as being incorporated into ethylene oxide/propylene oxide block copolymer surfactants that are waxy solids or pastes at room temperature, it is understood that the pour point depressants of the present invention could potentially be used with ethylene oxide/propylene oxide block copolymers that are not solids or pastes at room temperature. For example, the pour point depressants of the present invention are useful in reducing the pour point of fluid ethylene oxide/propylene oxide block copolymer surfactants that are to be employed in low temperature applications.

The following examples are illustrative of the present invention, and are should not be considered as delimitive of the scope of the invention in any way. All parts and percentages are expressed in weight percent.

### EXAMPLE 1

SURFONIC® POA P-104 and SURFONIC® DOS-75 PG (both available from Huntsman Petrochemical Corporation of Houston, Tex.), water, and propylene glycol, were mixed together in the ratios detailed in Table 1. The clarity and pour point of the resulting products were determined visually, and are detailed in Table 1.

TABLE 1

| | % | | | % | clarity @ | pour point |
|---|---|---|---|---|---|---|
| | SURFONIC ® | % | % propylene | SURFONIC ® | pour | (° C.) ASTM |
| | POA P-104¹ | H₂O | glycol | DOS-75 PG | point | D-97 |
| 1 | 70.00 | 10.00 | 0.00 | 20.00 | hazy | 0 |
| 2 | 75.00 | 10.00 | 0.00 | 15.00 | hazy | 5 |
| 3 | 70.00 | 15.00 | 5.00 | 10.00 | clear | 20 |
| 4 | 70.00 | 10.00 | 10.00 | 10.00 | clear | 5 |
| 5 | 70.00 | 10.00 | 5.00 | 15.00 | hazy | 0 |
| 6 | 71.25 | 11.25 | 6.25 | 11.25 | clear | 15 |
| 7 | 75.00 | 10.00 | 0.00 | 15.00 | hazy | 5 |
| 8 | 76.25 | 11.25 | 1.25 | 11.25 | hazy | 25 |
| 9 | 71.25 | 11.25 | 1.25 | 16.25 | hazy | 5 |
| 10 | 70.00 | 15.00 | 0.00 | 15.00 | hazy | 15 |
| 11 | 70.00 | 20.00 | 0.00 | 10.00 | clear | 25 |
| 12 | 75.00 | 10.00 | 5.00 | 10.00 | clear | 25 |
| 13 | 71.25 | 16.25 | 1.25 | 11.25 | clear | 25 |
| 14 | 70.00 | 20.00 | 0.00 | 10.00 | clear | 20 |
| 15 | 80.00 | 10.00 | 0.00 | 10.00 | hazy | 25 |
| 16 | 70.00 | 10.00 | 10.00 | 10.00 | clear | 5 |
| 17 | 70.00 | 10.00 | 0.00 | 20.00 | hazy | 0 |
| 18 | 75.00 | 15.00 | 0.00 | 10.00 | clear | 25 |
| 19 | 80.00 | 10.00 | 0.00 | 10.00 | hazy | 25 |
| 20 | 72.50 | 12.50 | 2.50 | 12.50 | hazy | 20 |

¹SURFONIC ® POA P-104 is a 3,250 molecular weight EOₓ-PO_{y}-EO_{z} block copolymer with a 40% ethylene oxide content, in which x = 15, y = 33, and z = 15.

Table 1 demonstrates that the addition of propylene glycol generally has a favorable effect on the clarity of the resulting surfactant blend. Further, the addition of di-octyl sodium sulfosuccinate (SURFONIC® DOS-75 PG) generally has a favorable effect on reducing the pour point of the resulting surfactant blend.

### EXAMPLE 2

A mixture of 70% SURFONIC® POA P-104 and 20% SURFONIC® DOS-75 PG was mixed with water and propylene glycol in the ratios detailed in Table 2. The clarity and pour point of the resulting products were determined visually, and are detailed in Table 2.

TABLE 2

| | | % propylene | clarity @ pour | pour point (° C.) |
|---|---|---|---|---|
| | % water | glycol | point | ASTM D-97 |
| 1 | 10.00 | 0.00 | hazy | 0 |
| 2 | 10.00 | 0.00 | hazy | 0 |
| 3 | 10.00 | 0.00 | hazy | 0 |
| 4 | 0.00 | 10.00 | clear | 0 |
| 5 | 7.50 | 2.50 | hazy | 15 |
| 6 | 0.00 | 10.00 | clear | 0 |
| 7 | 2.50 | 7.50 | hazy | 5 |
| 8 | 5.00 | 5.00 | hazy | 0 |

Table 2 shows that the clarity of the resulting surfactant blend improves with the addition of propylene glycol, when the amount of the parent surfactant and dioctyl sodium sulfosuccinate are held constant.

### EXAMPLE 3

70% SURFONIC® POA P-104, 20% SURFONIC® DOS-75 PG, and 10% water were blended with 10% of each of the additives listed in Table 3. The clarity and pour point of each resulting mixture were determined visually, and are detailed in Table 3.

TABLE 3

| | | | pour point (° C.) |
|---|---|---|---|
| | Additive | clarity @ pour point | ASTM D-97 |
| 1 | propylene glycol¹ | clear | 10 |
| 2 | dipropylene glycol¹ | hazy | 0 |
| 3 | ethylene glycol¹ | clear | 20 |
| 4 | diethylene glycol¹ | clear | 20 |
| 5 | SURFONIC ® L12-3¹ | hazy | 0 |
| 6 | SURFONIC ® L10-3¹ | hazy | 0 |
| 7 | SURFONIC ® L108-85/5¹ | hazy | 0 |
| 8 | SURFONIC ® L24-2¹ | hazy | 0 |
| 9 | SURFONIC ® L24-3¹ | hazy | 0 |
| 10 | SURFONIC ® L24-4¹ | hazy | 0 |
| 11 | SURFONIC ® L12-6¹ | hazy | 0 |
| 12 | EPAL ® 108/85² | hazy | 0 |
| 13 | 2-ethyl hexanol³ | hazy | 0 |
| 14 | propylene carbonate¹ | hazy | 0 |
| 15 | butylene carbonate¹ | hazy | 0 |
| 16 | butyl carbitol⁴ | hazy | 0 |
| 17 | DOWANOL TPM ®⁵ | hazy | 0 |

¹manufactured by the Huntsman Petrochemical Corporation, Houston, Texas
²manufactured by Amoco Chemicals, Chicago, Illinois
³manufactured by the Ashland Chemical Company, Columbus, Ohio
⁴manufactured by Union Carbide, Danbury, Connecticut
⁵manufactured by Dow Chemical Company, Midland, Michigan

Table 3 demonstrates that very few additives produce a resulting product with a favorable clarity. Noticeably, the lower molecular weight glycols (i.e. propylene glycol, ethylene glycol, diethylene glycol) are the only additives that appear to promote a clear product.

### EXAMPLE 4

SURFONIC® POA P-104 was mixed with an additive mix in the ratios detailed in Table 4. The additive mix comprised a 1:1:1 mixture of SURFONIC® DOS-75 PG, propylene glycol, and water. The clarity and pour point of each resulting product were determined visually, and are detailed in Table 4.

TABLE 4

| | % | % | min. clear | | pour point |
|---|---|---|---|---|---|
| | SURFONIC ® | additive | temp. | clarity @ | (° C.) |
| | POA P-104 | mix | (° C.) | pour point | ASTM D-97 |
| 1 | 100 | 0 | — | hazy | 45 |
| 2 | 90 | 10 | 15 | hazy | 10 |
| 3 | 85 | 15 | 10 | hazy | 5 |
| 4 | 80 | 20 | 5 | hazy | 5 |
| 5 | 75 | 25 | 0 | clear | 0 |
| 6 | 70 | 30 | 0 | clear | 0 |
| 7 | 65 | 35 | 0 | clear | <0 |
| 8 | 60 | 40 | <−10 | clear | <−10 |
| 9 | 55 | 45 | <−10 | clear | <−10 |

Table 4 shows that the additive mix must comprise at least 25% of the blended surfactant for the resulting product to have both a reduced pour point and a favorable clarity.

TABLE 5
(Comparative)

| | | | pour point |
|---|---|---|---|
| | | | (° C.) |
| | | clarity @ | ASTM |
| | Surfactant | pour point | D-97 |
| 1 | SURFONIC ® POA P-104 | hazy | 43 |
| 2 | A product of the present invention, | clear | 0 |
| | comprising 70% SURFONIC ® POA P-104, | | |
| | 10% water, 10% SURFONIC ® | | |
| | DOS-75 PG, and 10% propylene glycol | | |
| 3 | Product produced by introducing alternating | hazy | 15 |
| | blocks of ethylene oxide and propylene oxide | | |
| | into SURFONIC ® POA P-104 | | |
| 4 | Product produced by alkoxylating | hazy | 15 |
| | SURFONIC ® POA P-104 with a 85:15 of | | |
| | ethylene oxide:propylene oxide mix | | |

Table 5 compares the clarity and pour point of SURFONIC® POA P-104 (#1 above) with the clarity and pour point of SURFONIC® POA P-104 that has been blended with the pour point depressants of the present invention (#2 above) and SURFONIC® POA P-104 that has been chemically altered to reduce the pour point (#3 and #4 above). The surfactant prepared according to the present invention has a dramatically lower pour point, and is the only surfactant with a favorable clarity.

Although illustrative embodiments have been shown and described, a wide range of modification, changes, and substitution is contemplated in the foregoing disclosure. In some instances, some features of the disclosed embodiments may be employed without a corresponding use of the other features. Accordingly, it is appropriate that the appended claims be construed broadly and in a manner consistent with the scope of the invention.

What is claimed is:

1. A process for preparing reduced pour point ethylene oxide/propylene oxide block copolymer surfactants, wherein a parent ethylene oxide/propylene oxide block copolymer surfactant is mixed with a pour point depressant, said pour point depressant comprising:
a. a low molecular weight glycol;
b. water; and
c. a dialkyl sulfosuccinate.

2. The process of claim 1, wherein the low molecular weight glycol is selected from propylene glycol, ethylene glycol, diethylene glycol, or mixtures thereof.

3. The process of claim 1, wherein the dialkyl sulfosuccinate comprises a C₄-C₁₂ dialkyl sulfosuccinate.

4. The process of claim 1, wherein the dialkyl sulfosuccinate comprises dioctyl sodium sulfosuccinate.

5. The process of claim 1, wherein less than about 85% by weight of the reduced pour point ethylene oxide/propylene oxide block copolymer comprises the parent ethylene oxide/propylene oxide block copolymer surfactant.

6. The process of claim 5, wherein at least about 5% by weight of the reduced pour point ethylene oxide/propylene oxide block copolymer surfactant comprises the low molecular weight glycol.

7. The process of claim 6, wherein at least about 5% by weight of the reduced pour point ethylene oxide/propylene oxide block copolymer surfactant comprises the dialkyl sulfosuccinate.

8. The process of claim 7, wherein at least about 5% by weight of the reduced pour point ethylene oxide/propylene oxide block copolymer surfactant comprises water.

9. The process of claim 1, wherein from about 55% to about 80% by weight of the reduced pour point ethylene oxide/propylene oxide block copolymer surfactant comprises the parent ethylene oxide/propylene oxide block copolymer surfactant.

10. The process of claim 9, wherein from about 5% to about 15% by weight of the reduced pour point ethylene oxide/propylene oxide block copolymer surfactant comprises the low molecular weight glycol.

11. The process of claim 10, wherein from about 5% to about 20% by weight of the reduced pour point surfactant comprises the dialkyl sulfosuccinate.

12. The process of claim 11, wherein from about 5% to about 15% by weight of the reduced pour point surfactant comprises water.

13. A reduced pour point ethylene oxide/propylene oxide block copolymer surfactant composition prepared by mixing a parent ethylene oxide/propylene oxide block copolymer surfactant with a pour point depressant, said pour point depressant comprising:
a. a low molecular weight glycol;
b. water; and
c. a dialkyl sulfosuccinate.

14. The reduced pour point ethylene oxide/propylene oxide block copolymer surfactant of claim 13, wherein the dialkyl sulfosuccinate comprises a C₄-C₁₂ dialkyl sulfosuccinate.

15. The reduced pour point ethylene oxide/propylene oxide block copolymer surfactant composition of claim 13, wherein the dialkyl sulfosuccinate comprises dioctyl sodium sulfosuccinate.

16. The reduced pour point ethylene oxide/propylene oxide block copolymer surfactant composition of claim 13, wherein the low molecular weight glycol is selected from the group consisting of: propylene glycol, ethylene glycol, diethylene glycol, or mixtures thereof.

17. The reduced pour point ethylene oxide/propylene oxide block copolymer surfactant of claim 13, wherein less than 85% by weight of the reduced pour point ethylene oxide/propylene oxide block copolymer surfactant composition comprises the parent ethylene oxide/propylene oxide block copolymer surfactant.

18. The reduced pour point ethylene oxide/propylene oxide block copolymer surfactant of claim 17, wherein at least 5% by weight of the reduced pour point ethylene oxide/propylene oxide block copolymer surfactant composition comprises the dialkyl sulfosuccinate.

19. The reduced pour point ethylene oxide/propylene oxide block copolymer surfactant of claim 18, wherein at least about 5% by weight of the reduced pour point ethylene oxide/propylene oxide block copolymer surfactant composition comprises water.

20. The reduced pour point ethylene oxide/propylene oxide block copolymer surfactant of claim 19, wherein at least 5% by weight of the reduced pour point ethylene oxide/propylene oxide block copolymer surfactant comprises the low molecular weight glycol.

21. A reduced pour point ethylene oxide/propylene oxide block copolymer surfactant, wherein:
a. less than about 85% by weight of the reduced pour point ethylene oxide/propylene oxide block copolymer surfactant comprises a parent ethylene oxide/propylene oxide block copolymer surfactant;
b. at least about 5% by weight of the reduced pour point ethylene oxide/propylene oxide block copolymer surfactant comprises a low molecular weight glycol;
c. at least about 5% by weight of the reduced pour point ethylene oxide/propylene oxide block copolymer surfactant comprises a dialkyl sulfosuccinate; and
d. at least about 5% by weight of the reduced pour point ethylene oxide/propylene oxide block copolymer surfactant comprises water.

22. The reduced pour point ethylene oxide/propylene oxide block copolymer surfactant of claim 21, wherein the dialkyl sulfosuccinate comprises a C₄-C₁₂ dialkyl sulfosuccinate.

23. The reduced pour point ethylene oxide/propylene oxide block copolymer surfactant of claim 21, wherein the dialkyl sulfosuccinate comprises dioctyl sodium sulfosuccinate.

24. The reduced pour point ethylene oxide/propylene oxide block copolymer surfactant of claim 21, wherein the low molecular weight glycol is selected from propylene glycol, ethylene glycol, diethylene glycol, or mixtures thereof.

25. A reduced pour point ethylene oxide/propylene oxide block copolymer surfactant, wherein:
a. from about 55% to about 85% by weight of the reduced pour point ethylene oxide/propylene oxide block copolymer surfactant comprises a parent ethylene oxide/propylene oxide block copolymer surfactant;
b. from about 5% to about 15% by weight of the reduced pour point ethylene oxide/propylene oxide block copolymer surfactant comprises a low molecular weight glycol;
c. from about 5% to about 20% by weight of the reduced pour point ethylene oxide/propylene oxide block copolymer surfactant comprises a dialkyl sulfosuccinate; and
d. from about 5% to about 15% by weight of the reduced pour point ethylene oxide/propylene oxide block copolymer surfactant comprises water.

26. The reduced pour point ethylene oxide/propylene oxide block copolymer surfactant of claim 25, wherein the dialkyl sulfosuccinate comprises a C₄-C₁₂ dialkyl sulfosuccinate.

27. The reduced pour point surfactant of claim 25, wherein the dialkyl sulfosuccinate comprises dioctyl sodium sulfosuccinate.

28. The reduced pour point surfactant of claim 25, wherein the low molecular weight glycol is selected from propylene glycol, ethylene glycol, diethylene glycol, or mixtures thereof.

29. A pour point depressant for reducing the pour point of ethylene oxide/propylene oxide block copolymer surfactants, wherein the pour point depressant comprises:
a. a low molecular weight glycol;
b. water; and
c. a dialkyl sulfosuccinate.

30. The pour point depressant of claim 29, wherein the low molecular weight glycol is selected from propylene glycol, ethylene glycol, diethylene glycol, or mixtures thereof.

31. The pour point depressant of claim 29, wherein the dialkyl sulfosuccinate comprises a C₄-C₁₂ dialkyl sulfosuccinate.

32. The pour point depressant of claim 29, wherein the dialkyl sulfosuccinate comprises dioctyl sodium sulfosuccinate.
